(19) United States
(12) Patent Application Publication
(10) Pub. No.: US 2011/0297005 A1
(43) Pub. Date: Dec. 8, 2011

(54) CAPSULE FOR PREPARING A DRINK

(76) Inventor: Alain Mariller, Le Mont-Pelerin (CH)

(21) Appl. No.: 13/146,108

(22) PCT Filed: Jan. 22, 2010
(86) PCT No.: PCT/IB10/50297

§ 371 Date: Aug. 18, 2011

(30) Foreign Application Priority Data
Jan. 23, 2009 (IB) PCT/IB2009/050281
Apr. 21, 2009 (IB) PCT/IB2009/051636
Jul. 3, 2009 (IB) PCT/IB2009/052898

(51) Int. Cl. A47J 31/00

(52) U.S. Cl. 99/295; 99/289 P; 206/524.6

(57) ABSTRACT

The invention relates to a capsule for preparing a drink, for example coffee, comprising a hollow element (1,1a,1b) for containing a dose, for example of ground coffee. Said hollow element (1,1a,1b) has a lateral wall (2, 2a, 2b), an upper face (3) and a lower face (4), the lower part of said lateral wall (2, 2a, 2b) extending in such a way as to create a rim (6, 3a, 3b) oriented along a plane cutting the lateral wall (2, 2a, 2b). The invention is characterised in that the thickness of the upper face (3) and/or the lateral wall (2, 2a, 2b) and/or the rim (6, 3a, 3b) is variable.

### FIELD OF THE INVENTION

The present invention is situated in the field of the preparation of drinks, for example based on coffee, by extraction of a concentrated dose, for example of ground coffee, contained in a capsule. It relates more particularly to the doses used for this purpose and to the devices using such doses.

### DESCRIPTION OF THE PRIOR ART

Capsules and machines operating according to the aforementioned principle have existed for many decades.

Patents U.S. Pat. No. 2,899,886, U.S. Pat. No. 2,968,560, U.S. Pat. No. 3.403.617 and U.S. Pat. No. 3,607,297 describe devices in which the capsule is initially perforated in several locations then passed through by pressurized water.

The capsule described in patent CH 605 293 or in patent EP 0 242 556 B1 comprises a membrane in its bottom portion. Pressurized water is initially inserted into the top portion of the capsule, which causes the capsule to swell, mainly at the membrane. From a certain pressure, the membrane tears, thereby allowing a water-coffee mixture to flow.

Other capsules furnished with a membrane are described in the following patent documents: EP 0 468 079 A, EP 0 806 373 A, EP 0 554 469 A.

Although the majority of the hot water inserted under pressure enters and passes through the capsule, another portion flows outside the latter, along the outer face of the side wall. In principle, these leakages should not flow beyond the base of the side wall because, at this location, the capsule cage is in contact with the rim.

Unfortunately this is not the case with the capsules and the capsule cages of the prior art. Liquid can therefore flow outside the machine and/or mix with the liquid that has passed inside the capsule. In the latter situation, the quality of the coffee is diminished.

There is therefore a need to reduce, or even eliminate, the leakages of liquid that flows along the outer face of the side wall of the capsule.

### SUMMARY OF THE INVENTION

One of the objectives of the present invention lies in improving the flow of the liquid through the capsule. The object of the invention is to prevent liquid flowing along the side wall of the capsule.

By “extra thickness”, it should be understood that the element concerned, namely the top face, the side wall or rim, comprises a portion the thickness of which is greater than the thickness that forms the other portion of the element concerned. It should however be noted that this increased thickness does not result from a fold (double layer) of the side wall.

The material of the side wall and the rim is preferably elastic.

Advantageously, it is a biodegradable material.

Several equivalent ways of forming a rim having a greater thickness or an extra thickness are possible and are illustrated as exemplary embodiments in the present application. Naturally, they are examples that must not be considered limiting and variants are possible in the context of the present application.

Similarly, by “lesser thickness”, it should be understood that the element concerned, namely the top face, the side wall or rim, comprises a portion the thickness of which is smaller than the thickness that constitutes the other portion of the element concerned.

Most frequently, the presence of an extra thickness is designed to improve the seal while the presence of a lesser thickness is designed to weaken the element concerned, for example in order to make it easier to pierce.

According to one variant of the invention, the seal between the rim and the bottom portion of the capsule cage is improved by virtue of the softening of the material that forms the capsule. Specifically, when water flows over the outer face of the wall of the capsule and contacts the rim, the latter softens. The capsule cage may therefore sink more deeply into the thickness of the rim. The seal at this location is therefore improved.

Any material that behaves as indicated above, that is to say softens, can be used in the context of the present invention.

According to another variant of the invention, the capsule comprises a gutter which is designed to be deformed at least partially by the cage when the device is closed.

It should however be noted that the invention is not limited to the aforementioned fields of use. One or more extra thicknesses, respectively one or more lesser thicknesses, may be used for other purposes. The presence of extra thicknesses placed in the bottom portion of the side wall may be used to make it easier to center the capsule in the capsule cage.

### DETAILED DESCRIPTION OF THE INVENTION

1^{st} Series of Examples

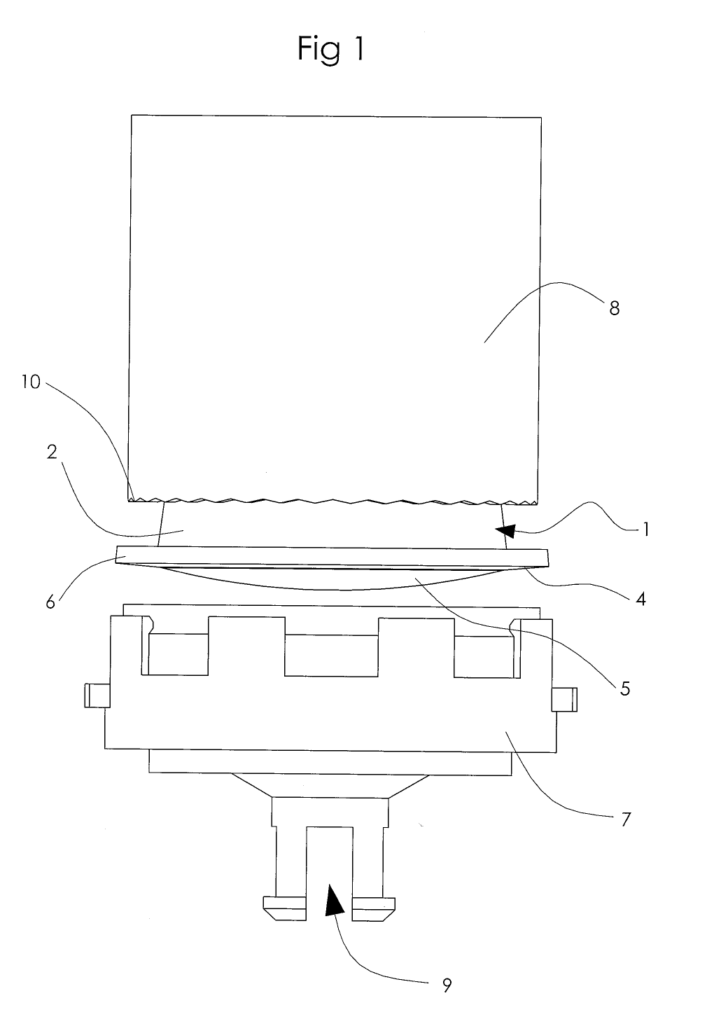

FIG. 1 shows a first embodiment of a device and of a capsule according to the invention.

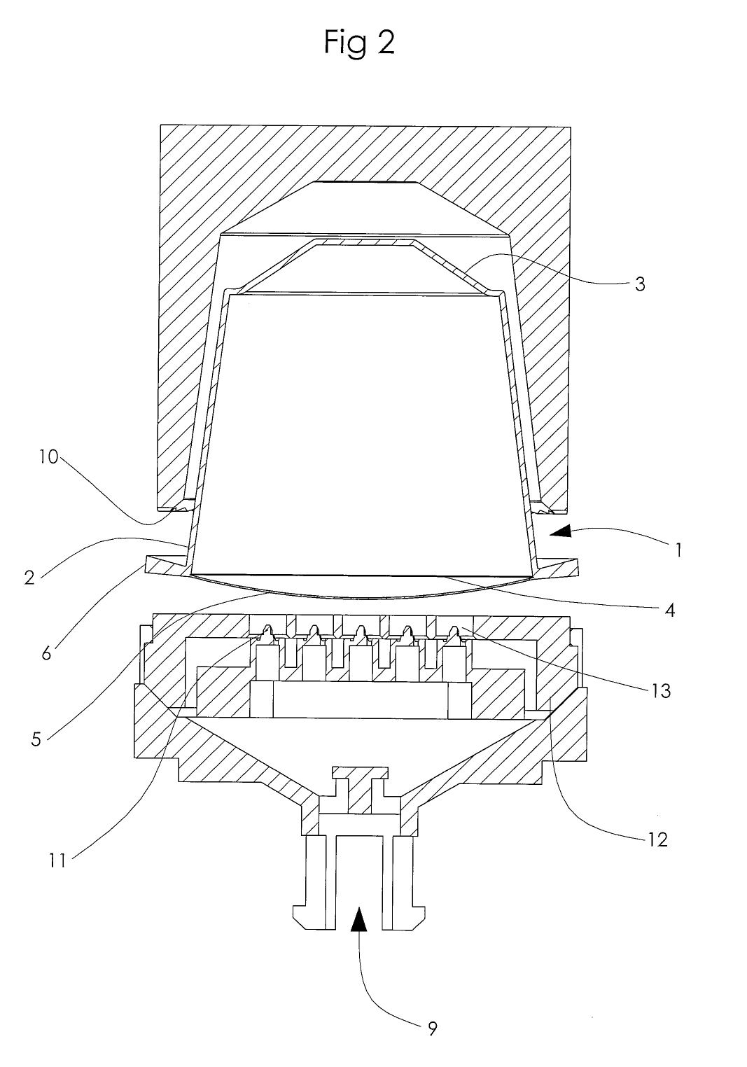

FIG. 2 shows a section of the object of FIG. 1 in the open position.

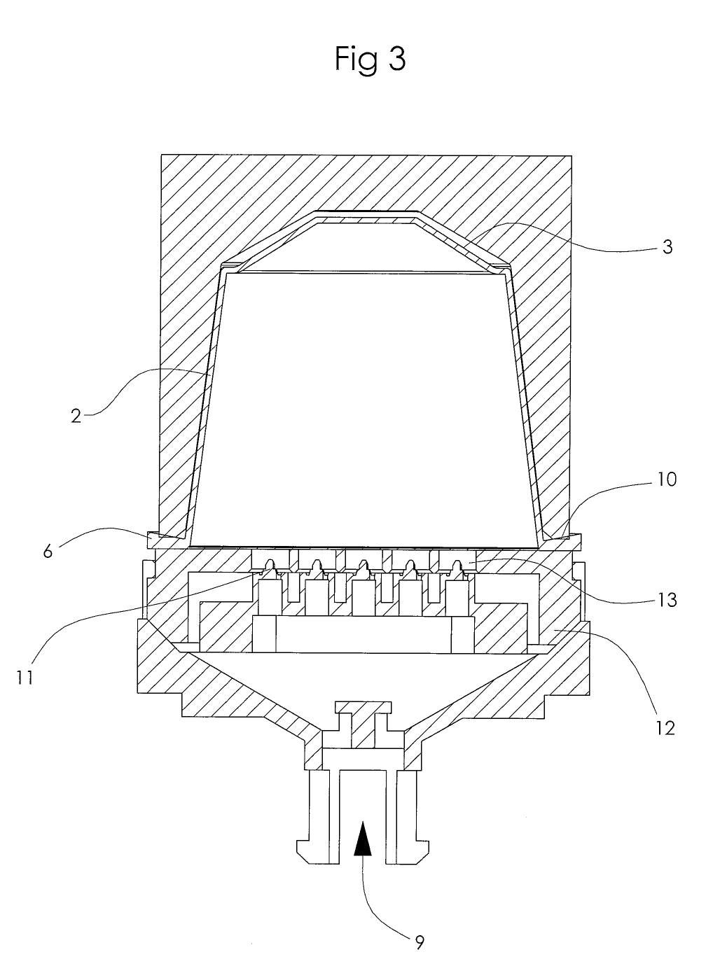

FIG. 3 shows a section of the object of FIG. 1 in the closed position.

FIG. 4 illustrates an enlargement of the zone of contact between the rim of the capsule and the device of FIG. 1.

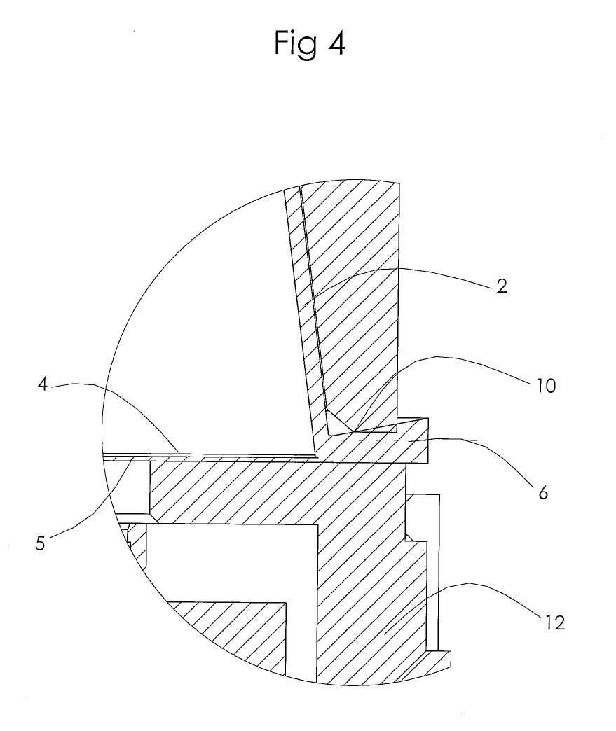

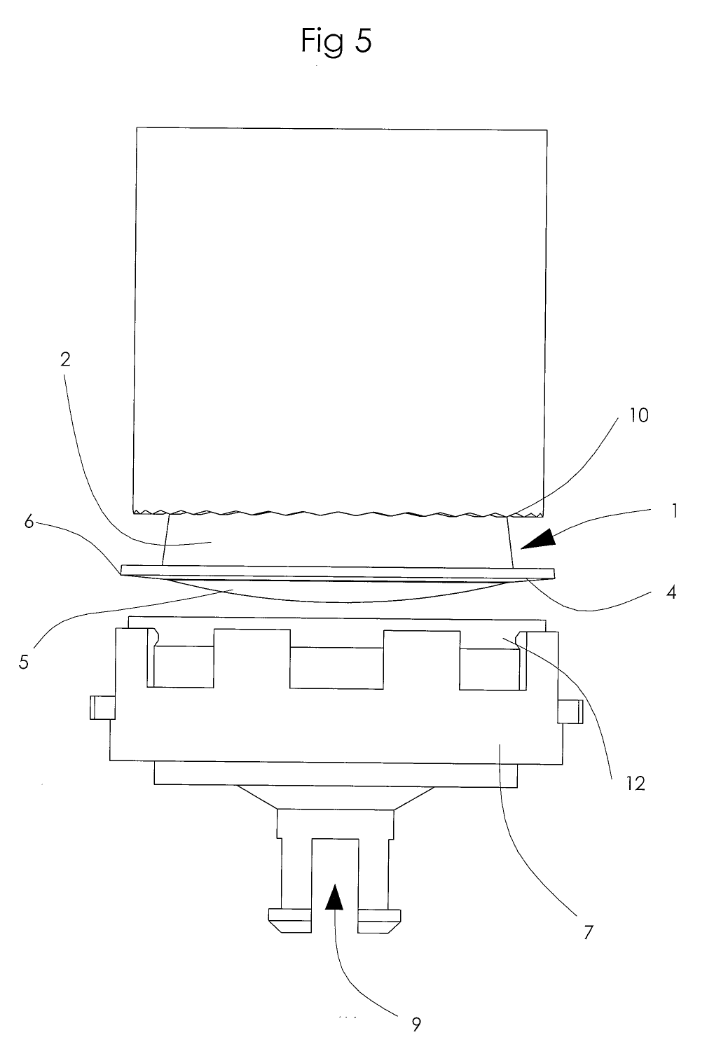

FIG. 5 shows a second embodiment of a device and of a capsule according to the invention.

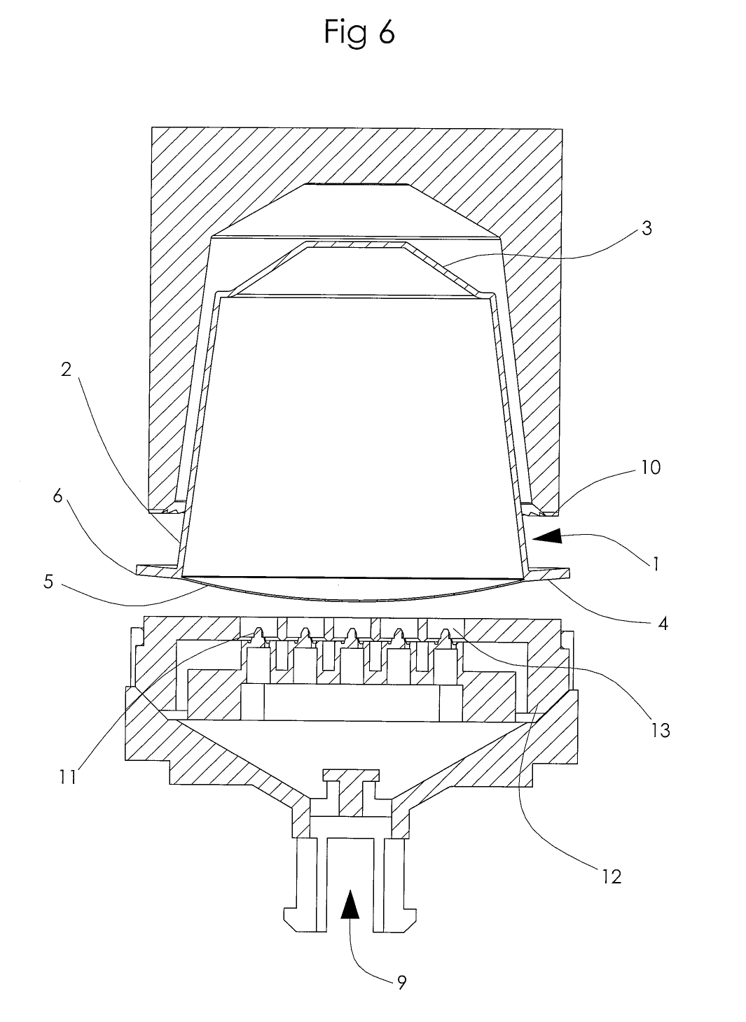

FIG. 6 shows a section of the object of FIG. 5 in the open position.

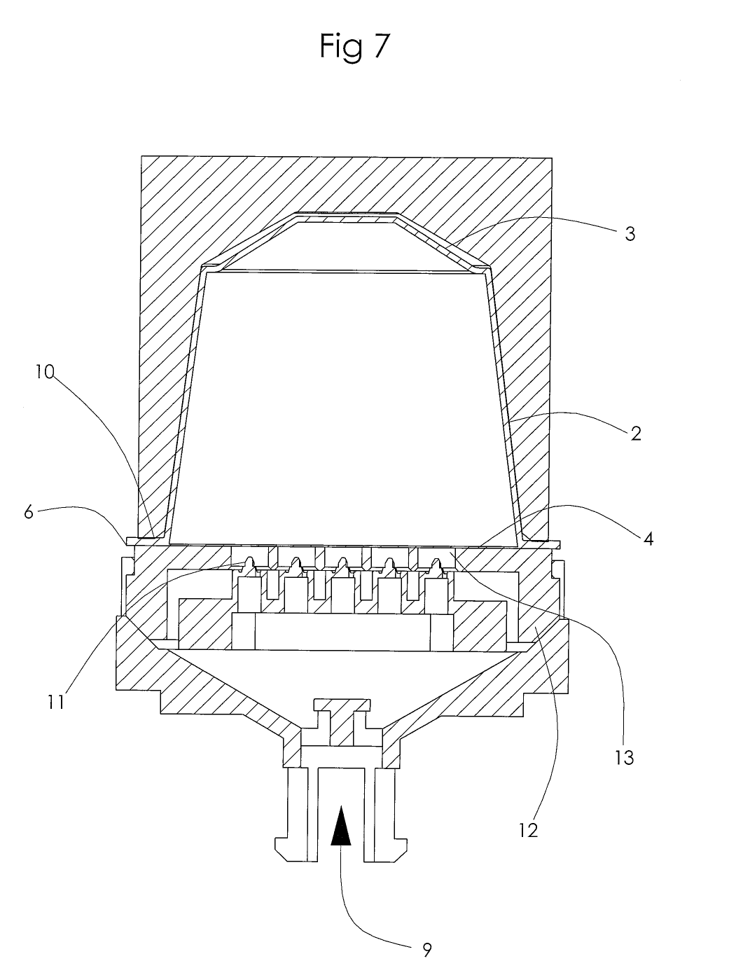

FIG. 7 shows a section of the object of FIG. 5 in the closed position.

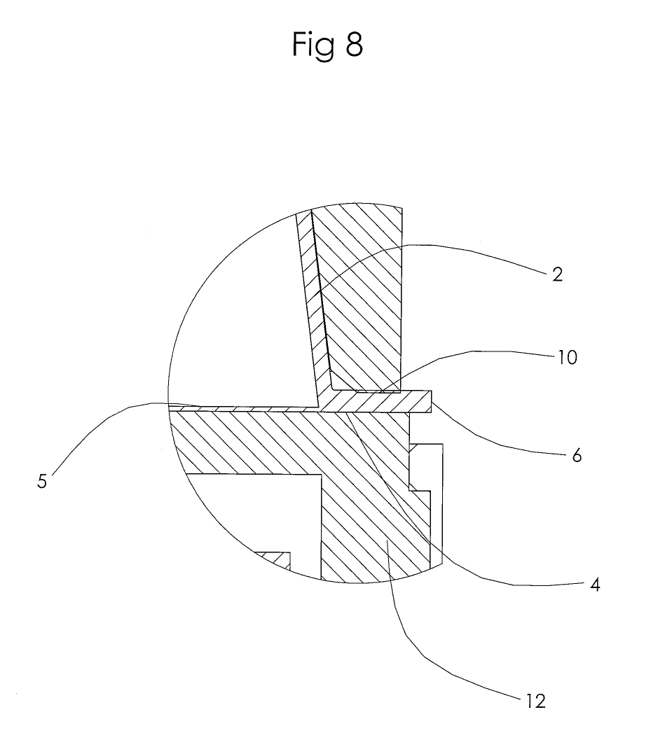

FIG. 8 illustrates an enlargement of the zone of contact between the rim of the capsule and the device of FIG. 5.

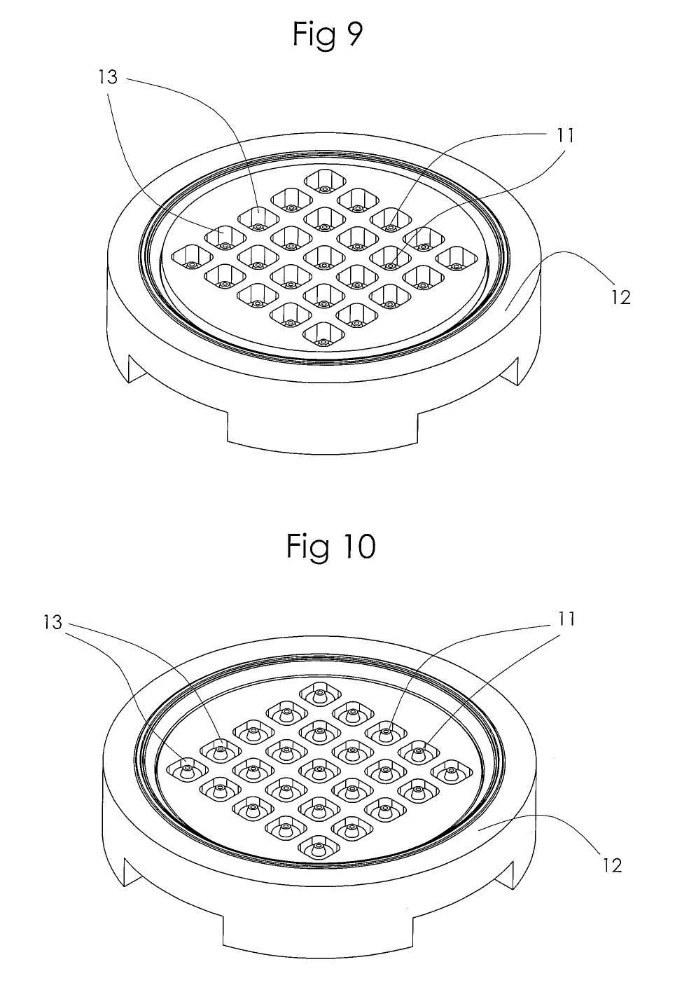

FIG. 9 illustrates an embodiment of a capsule holder with perforation elements in the retracted position.

FIG. 10 the capsule holder of FIG. 9 with the perforation elements in the active position.

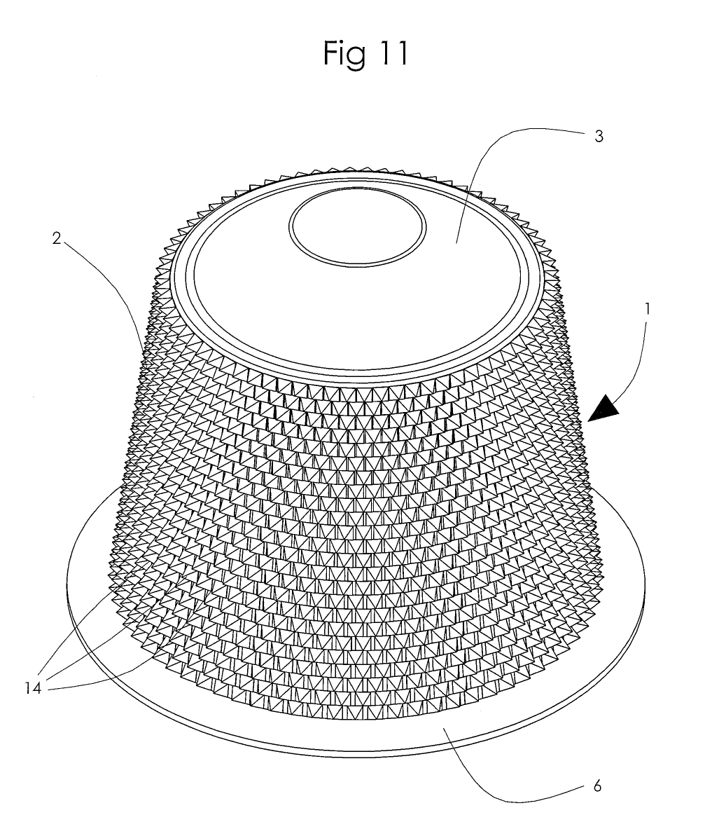

FIG. 11 illustrates an example of a capsule comprising elastic extra thicknesses on its side face. The extra thicknesses form an integral portion of the side wall. They are therefore formed of the same material.

FIGS. 12 and 13 illustrate another form of extra thickness on the side wall, but spiral-shaped.

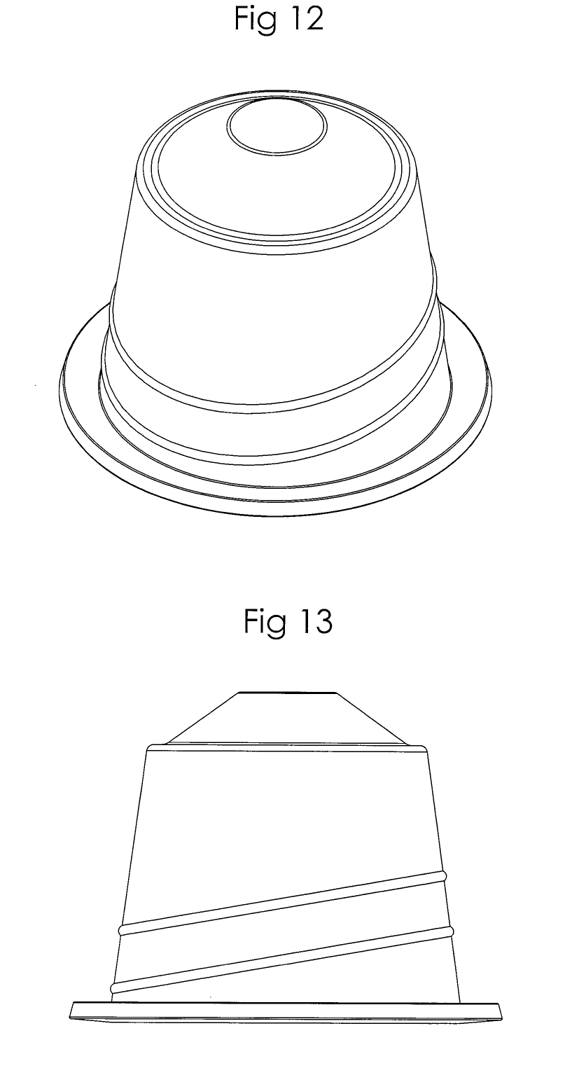

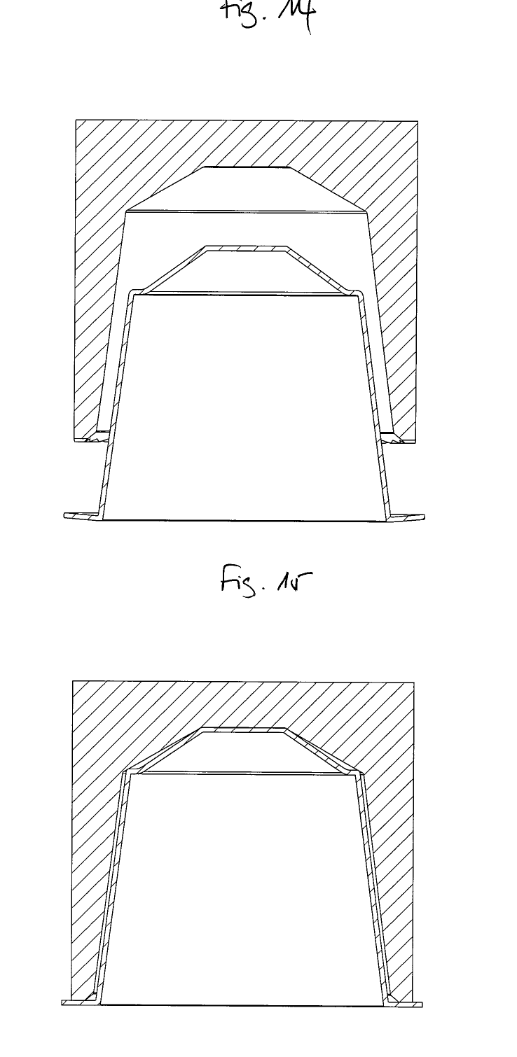

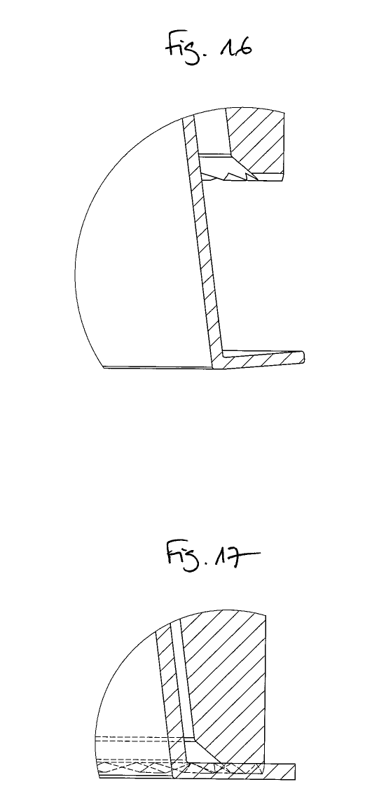

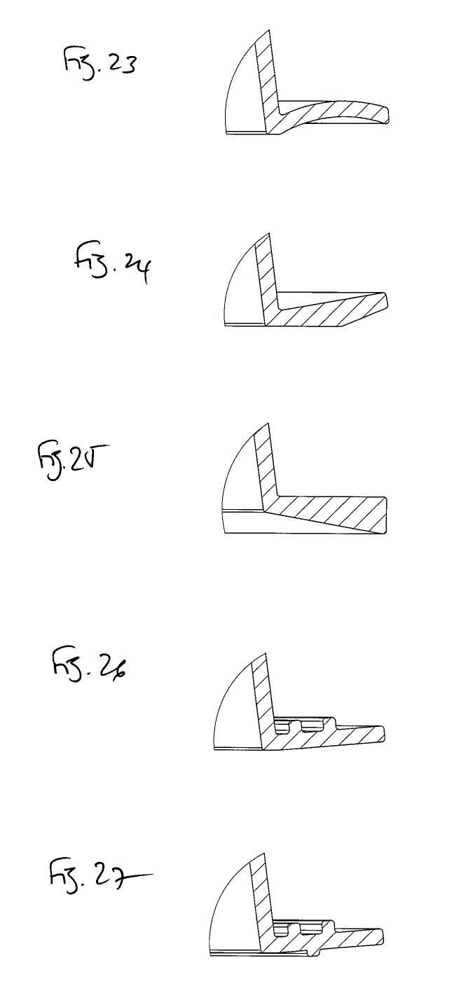

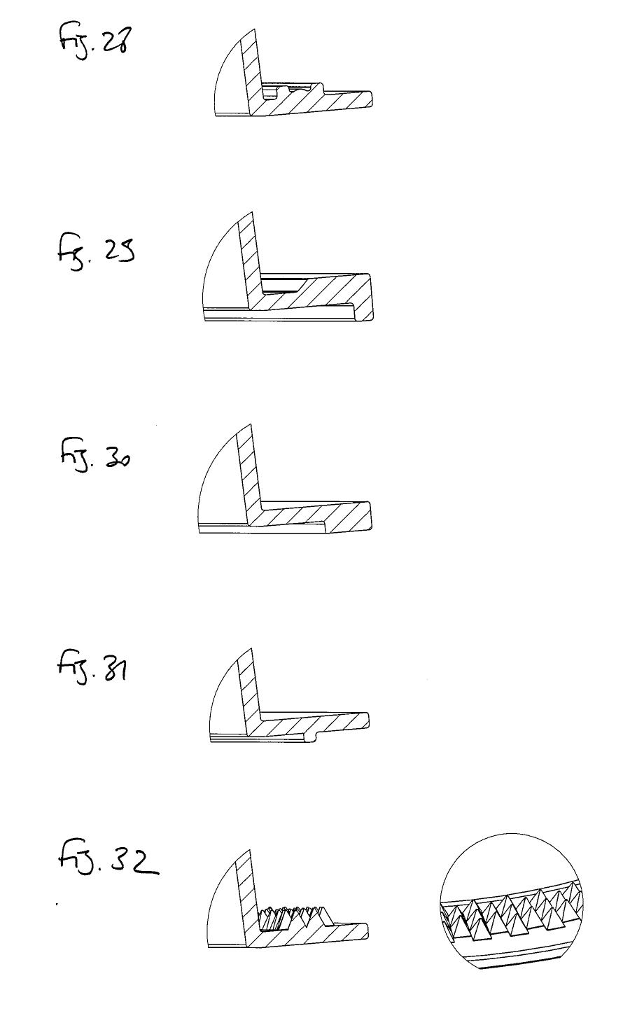

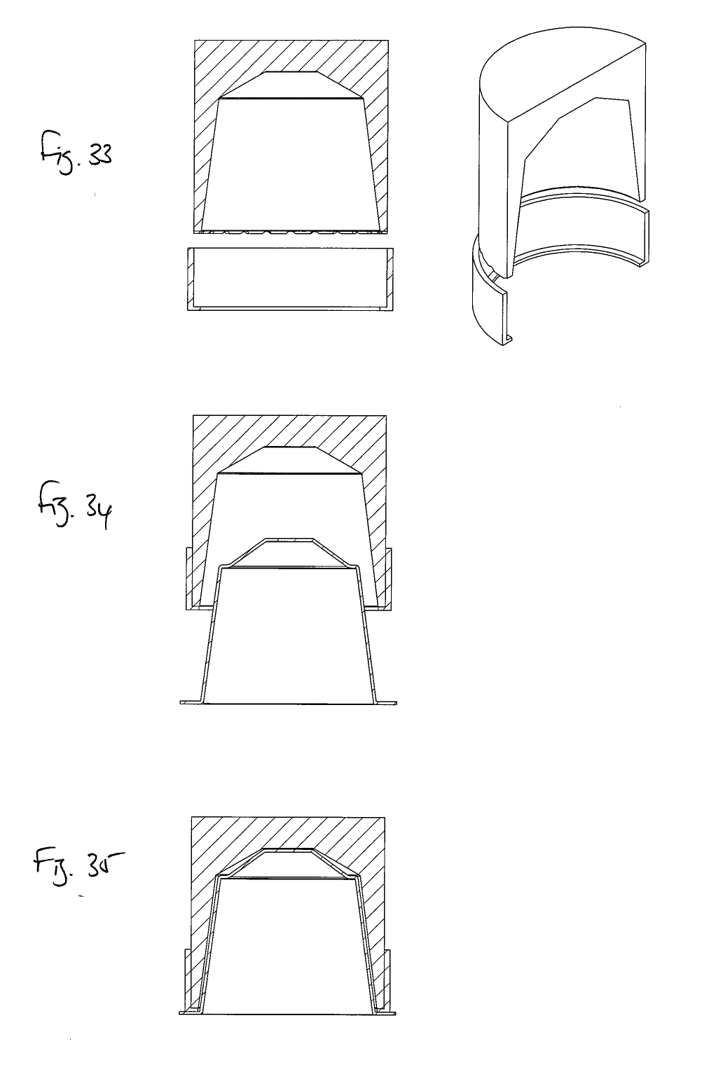

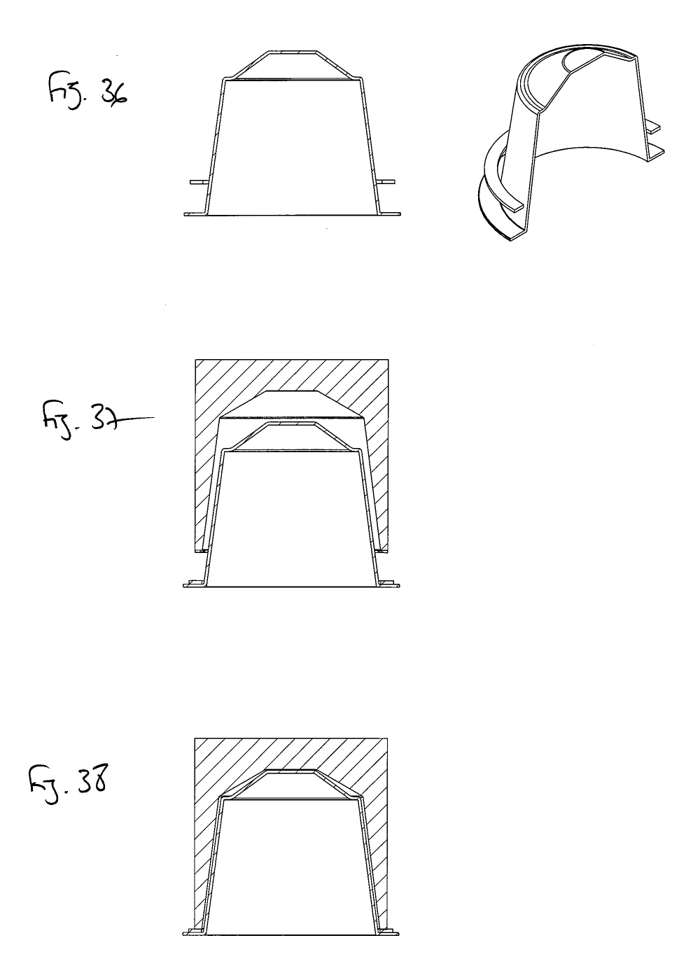

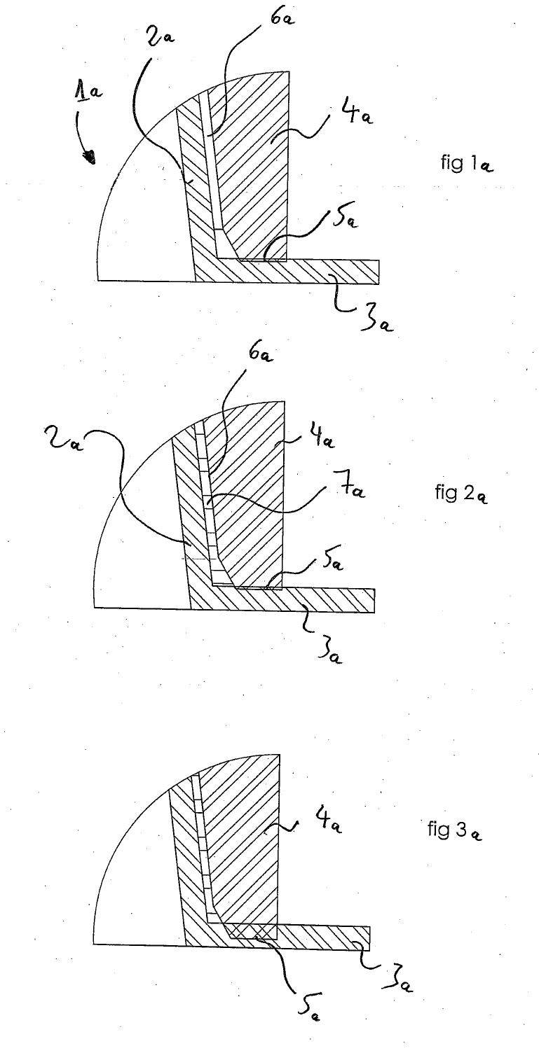

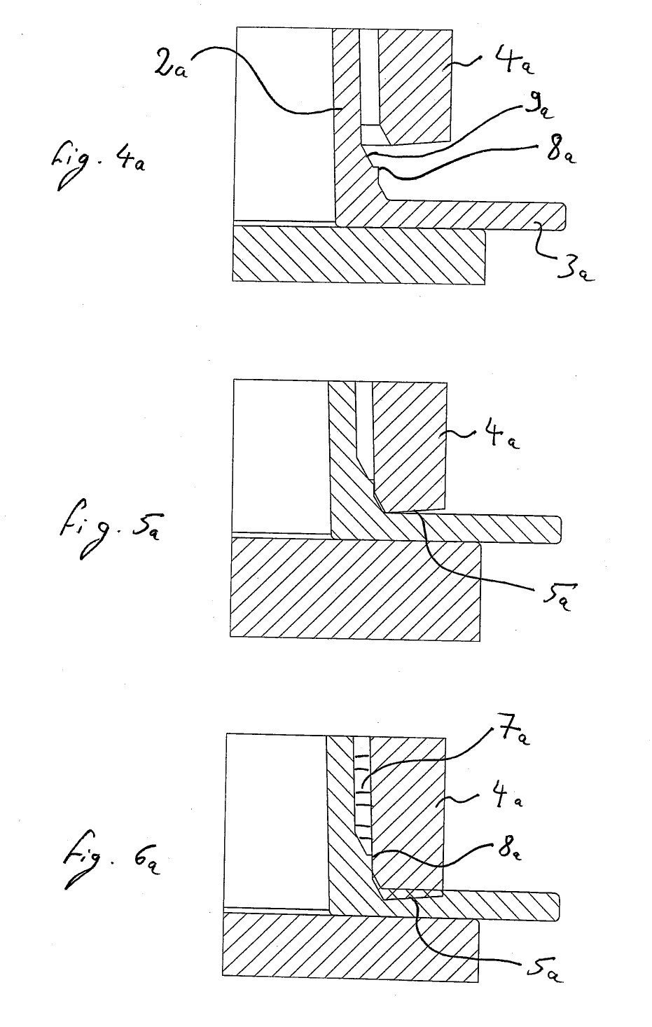

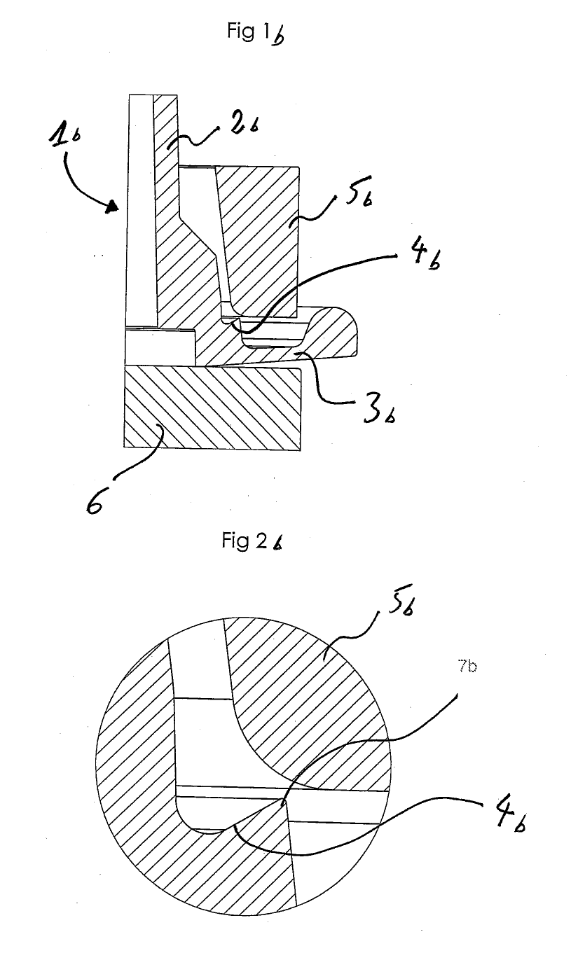

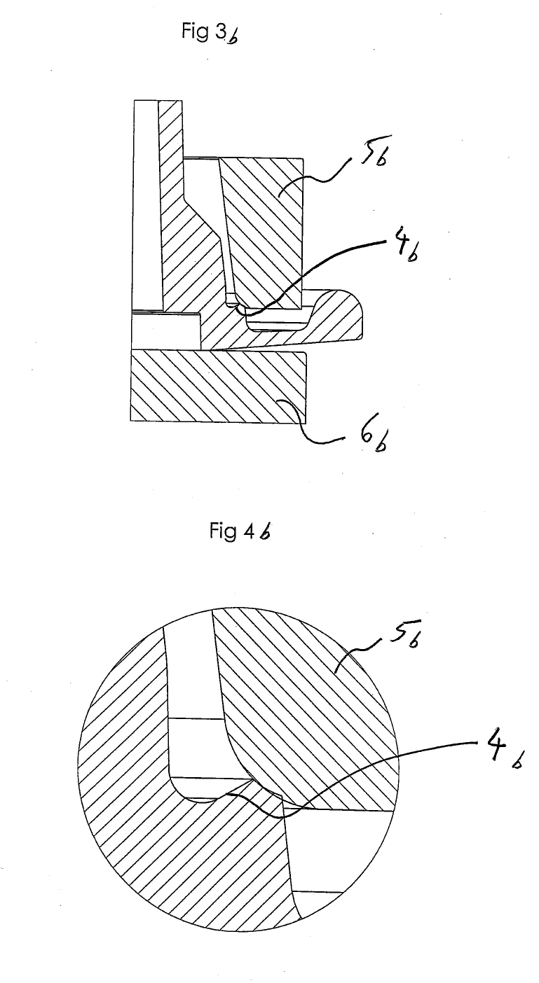

FIGS. 14 to 38 illustrate particular embodiments of the invention.

Reference Numbers used in FIGS. 1 to 38:

1. Hollow element

2. Side wall

3. Top face

4. Bottom face

5. Extraction membrane

6. Rim

7. Capsule holder

8. Capsule housing

9. Liquid outlet

10. Bottom portion of the capsule housing

11. Membrane perforation element

12. Plate

13. Hole

14. Side extra thickness

Preferably, the top face of the rim 6 forms an angle of less than 90° with the side wall, which has the effect of making it easier for the capsule housing to penetrate the rim 6.

The plate illustrated in FIGS. 9 and 10 is made movable while the perforation elements 11 are fixed. The movement of the plate occurs starting from a certain pressure that prevails in the capsule. Beneath this threshold pressure, the plate is held by an element, for example a calibrated leaf spring.

The bottom edge of the capsule cage illustrated in FIGS. 16 and 17 comprises a crenelated relief the object of which is to increase the area of contact with the rim of the capsule and to make it easier for the cage to penetrate the rim. The seal at this level is therefore improved.

FIGS. 19 to 32 represent various embodiments of extra thicknesses and of lesser thicknesses that are placed on the rim.

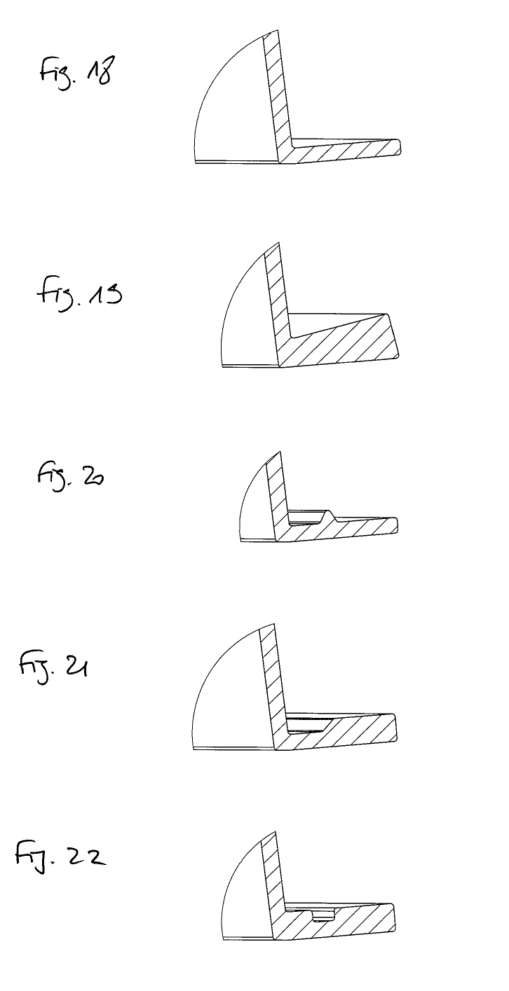

Note in particular certain examples (see FIGS. 23, 25, 29, 30) which have recesses on the side of the bottom face of the rim. The latter may for example be used as housings for the insertion of elements that form the base of the capsule such as rings or rigid disks. The making of hollows on the rim may also be used to increase its flexibility.

2^{nd} Series of Examples

FIG. 1a represents a capsule 1a according to a first embodiment of the invention after closure of the cage 4a, but prior to the entry of hot water.

FIG. 2a illustrates the entry of hot water 7a, mainly into the capsule 1a, but also into the space 6a that is situated between the outer face of the side wall 2a of the capsule and the inner face of the cage 4a.

FIG. 3a illustrates the positioning of the cage 4a relative to the rim, after the latter has softened.

FIGS. 4a to 6a illustrate a second embodiment of the invention.

List of Reference Numbers used in FIGS. 1a to 6a:

1a. Capsule

2a. Side wall

3a. Rim

4a. Cage

5a. Bottom portion of cage

6a. Space between the capsule and the cage

7a. Water

8a. Chicane

9a. Inclined wall portion

According to the invention, the capsule la for the preparation of a drink, for example coffee, comprises a hollow element designed to contain a dose, for example of ground coffee. The hollow element comprises a side wall 2a, a top face, a bottom face with an extraction membrane and a rim 3a; said side wall 2a extending in its bottom portion so as to form said rim 3a, the latter being oriented on a plane that intersects said side wall 2a. According to the invention, the rim 3a is formed at least partially of a material that softens when it is placed in contact with a liquid.

Preferably, the softening temperature of said material is higher than the ambient temperature.

The capsule illustrated in FIGS. 4a to 6a differs from the capsule of FIGS. 1a to 3a only in that the base of the side wall 2a forms an inclined annular zone 9a and that a bulge 8a is placed on the latter.

The bulge 8a is of a size to reduce (and not remove) the cross section of the passageway through which the liquid flows. The bulge 8a therefore does not constitute a seal but rather a chicane which has the effect of slowing the quantity of liquid that comes into contact with the rim 3a.

Specifically it has been found that, surprisingly, the slowing of the quantity of liquid contacting the rim 3a improves the seal between the capsule cage 4a and the rim 3a.

3^{rd} Series of Examples

FIG. 1b represents a partial view in section of a capsule according to the invention in the cage in a first position;

FIG. 2b illustrates a detail of FIG. 1b;

FIG. 3b illustrates a partial view in section of the capsule of FIGS. 1b and 2b in a second position;

FIG. 4b illustrates a detail of FIG. 3b.

According to the invention and as illustrated in the figures, the capsule 1b comprises a side wall 2b and a rim 3b. The capsule 1b is placed on a support 6b and is surrounded by a cage 5b.

A gutter 4b is placed in the bottom portion of the side wall 2b. The gutter 4b is formed notably of a ridge 6b that is oriented so as to face the cage portion 5b designed to come into contact with it.

In FIGS. 1b and 2b, the cage is in the open position.

FIG. 2b illustrates an enlargement of FIG. 1b above.

FIGS. 3b and 4b illustrate the effect of the cage 5b on the gutter 4b when the capsule 1b is clamped in its cage 5b.

FIG. 4b illustrates an enlargement of FIG. 3b.

List of reference numbers used in FIGS. 1b to 4b:

1b. Capsule

2b. Side wall

3b. Rim

4b. Gutter

5b. Cage

6b. Support

As can be seen in FIGS. 3b and 4b, the cage 5b sinks into the gutter 4b because the latter has previously been softened following the arrival of liquid in the space that is situated between the cage 5b and the side wall 2b.

The presence of the gutter 4b has the effect of slowing the flow rate of the hot water, or of containing it, while the block of material used as a base for the gutter 4b softens. The sinking of the cage 5b into the bottom portion of the side wall 2b is therefore increased which has the effect of improving the seal at this location, the liquid not being able to flow beyond the gutter 4b.

The present invention is not limited to the examples and modes of execution described purely as an illustration. Variations are possible in the context of the claimed protection, notably by making use of equivalent means. This relates particularly to the shape of the extra thicknesses, of the lesser thicknesses and of the gutter. It will be noted finally that it is not necessary to furnish the base of the capsule with an inclined wall portion.

1. A capsule for the preparation of a drink, for example coffee, comprising a hollow element (1, 1a, 1b) designed to contain a dose, for example of ground coffee, said hollow element (1, 1a, 1b) comprising a side wall (2, 2a, 2b), a top face (3) and a bottom face (4); said side wall (2, 2a, 2b) extending in its bottom portion so as to form a rim (6, 3a, 3b) oriented on a plane that intersects said side wall (2, 2a, 2b), characterized in that the thickness of said top face (3) and/or of said side wall (2, 2a, 2b) and/or of said rim (6, 3a, 3b) is variable.

2. The capsule as claimed in claim 1, wherein said top face (3) and/or said side wall (2, 2a, 2b) and/or said rim (6, 3a, 3b) comprises/comprise an extra thickness.

3. The capsule as claimed in claim 1, wherein said top face (3) and/or said side wall (2, 2a, 2b) and/or said rim (6, 3a, 3b) comprises/comprise a lesser thickness.

4. The capsule as claimed in claim 1, wherein said top face (3), said side wall (2, 2a, 2b) and said rim (6, 3a, 3b) are formed of an elastic material.

5. The capsule as claimed in claim 1, wherein said top face (3), said side wall (2, 2a, 2b) and said rim (6, 3a, 3b) are formed of a biodegradable material.

6. The capsule as claimed in claim 1, wherein said top face (3), said side wall (2, 2a, 2b) and said rim (6, 3a, 3b) are formed of a material that softens in contact with a liquid.

7. The capsule as claimed in claim 6, wherein the material forming the rim (3a) is suitable for softening in contact with a liquid of which the temperature is greater than the ambient temperature.

8. The capsule as claimed in claim 7, comprising a gutter (4b) in the bottom portion of the side wall (2b), the gutter (4b) being placed so as to ensure a contact with the cage (5b) of a device for the preparation of a drink.

9. The capsule as claimed in claim 8, wherein the gutter (4b) comprises a ridge (7b) oriented so as to face the portion of cage (5b) designed to come into contact with it.

10. The capsule as claimed in claim 1, wherein the bottom portion of the side wall (2, 2a, 2b) is thicker than the top portion.

11. The capsule as claimed in claim 1, comprising an annular bulge (8a) placed toward the base of the side wall (2, 2a, 2b) and of a size to form a chicane for the liquid flowing over the outer face of the side wall (2, 2a, 2b).

12. The capsule as claimed in claim 1, in which the thickness of the rim (6, 3a, 3b) increases in the direction of its periphery.

13. The capsule as claimed in claim 1, wherein the top face of the rim (6, 3a, 3b) or at least a portion of said face forms an angle of more than 90° with the side wall (2, 2a, 2b).

14. The capsule as claimed in claim 1, wherein the top face of the rim (6, 3a, 3b) or at least a portion of said face forms an angle of less than 90° with the side wall (2, 2a, 2b).

15. A device for the use of a capsule as defined in claim 1, comprising a capsule holder (7), a capsule housing (8), a water inlet, a perforation element and a liquid outlet (9), wherein the bottom portion (10) of said capsule housing (8) is suitable for penetrating the rim (6) and/or said extra thickness so as to ensure an optimal seal.

16. The device as claimed in claim 15, wherein the bottom portion (10) of said capsule housing (8) comprises an indented relief.

17. A device for the use of a capsule for the preparation of a drink, for example coffee, comprising a hollow element designed to contain a dose, for example of ground coffee, said hollow element comprising a side wall, a top face and a bottom face comprising an extraction membrane, said device comprising a capsule holder (7), a capsule housing (8), a water inlet, an element for perforating the hollow body, elements (11) for perforating said membrane, and a liquid outlet, said housing comprising a plate (12) furnished with a series of holes (13) through which said membrane perforation elements (11) can slide, wherein said plate (12) is made movable while said membrane perforation elements (11) are fixed.
